(19) United States
(12) Patent Application Publication
(10) Pub. No.: US 2021/0396259 A1
(43) Pub. Date: Dec. 23, 2021

(54) QUICK ATTACHMENT ARRANGEMENT

(71) Applicant: GRIP ROSE OY, Helsinki (FI)

(72) Inventors: Sami YLIKAHRI, Helsinki (FI); Leon SCHADVOYN, Evitskog (FI); Niklas KAARLA, Helsinki (FI); Jyrkir GRÖHN, Ylämylly (FI)

(21) Appl. No.: 17/292,029

(22) PCT Filed: Nov. 8, 2019
(86) PCT No.: PCT/FI2019/000018

§ 371 Date: May 7, 2021

(30) Foreign Application Priority Data
Nov. 8, 2018 (FI) 20187161

(51) Int. Cl. F16B 21/04

(52) U.S. Cl. CPC F16B 21/04

(57) ABSTRACT

A mechanism allowing reliable, durable and easily releasable attachment of a member to a base mechanism is disclosed. The mechanism includes a quick attachment arrangement having a lock base and a rotatable lock ring within the lock base, the lock base and lock ring being arranged to receive a wedge plate for insertion into the lock base within the lock ring, and to securely attach an inserted wedge plate by rotation of the lock ring. In the inventive arrangement the lock ring is arranged to move, in a direction perpendicular to the plane of the lock ring, towards a wedge plate inserted into the lock base when rotated in a first direction for securing the wedge plate in the lock base, and to release the wedge plate when rotated in the second direction.

### CROSS REFERENCE TO RELATED APPLICATIONS

This application is a national phase application of International Application PCT/FI2019/000018, filed Nov. 8, 2019 and claims the benefit of Finnish patent application 20187161, filed Nov. 8, 2018, the both of which are herein incorporated by reference.

### BACKGROUND OF THE INVENTION

The present disclosure is generally related to attachment mechanisms, and particularly to mechanisms allowing reliable, durable and easily releasable attachment of a member to a base mechanism.

There are many different attachment mechanisms or devices known in the prior art. The following sets out certain attachment mechanisms which allow for easy attachment and detachment to objects with and from each other. U.S. Pat. No. 4,153,359 describes a bayonet mechanism which has a spring action locking function. This arrangement allows an object to be fastened to a base unit by inserting the object and turning it until the locking lever member engages with the object. These types of solutions are well known from many different industries. Another bayonet type mechanism which is rather flat and planar is described in the U.S. patent application US2004129186.

In addition to the aforementioned, different kinds of twisting and locking arrangements are also known in the art. For example, U.S. Pat. No. 7,537,409 describes an element which can be used for attaching elements of furniture to each other. This element allows insertion of one piece of the element into another and then the user can turn one of the elements whereby they are locked to each other.

Another similar structure is described in the PCT patent application WO9104421 which describes a releasable connector which also provides a twist and lock mechanism.

A locking mechanism is described in U.S. Pat. No. 5,660,493. This patent describes an attachment mechanism of a wet-dry vacuum cleaner for selectively mounting an air blower on a lid.

An attachment mechanism is described in the patent application PCT/FI2017/000008. This application describes an attachment mechanism, that has a lock base and a locking ring, which allow a wedge plate to be inserted into the lock base and securely attached into the lock base by rotation of the locking ring. While this mechanism provides an easily releasable mechanism, the mechanism has parts that are very complex in their shape.

### SUMMARY OF THE INVENTION

An invention set out in the present disclosure provides for an attachment arrangement that is stronger and simpler to manufacture than prior art solutions. The inventive arrangement comprises a lock base and a rotatable lock ring within the base. The lock base and the lock ring have an opening for insertion of a wedge plate. The wedge plate can be locked in the lock base by inserting the wedge plate and rotating the lock ring. In the inventive arrangement, the lock ring is arranged to move towards the wedge plate, in a direction perpendicular to the plane of the lock ring, when rotated in a first direction, to secure the wedge plate into the attachment arrangement. Such an approach allows the wedge plate to be of simple and sturdy construction, allowing the mating surfaces of the wedge plate and the lock ring to be flat.

This inventive approach avoids the need for complicated shaping of the wedge plate and the lock ring known from prior art solutions.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE SEVERAL VIEWS OF THE DRAWINGS

Further advantages features and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, with departing from the scope of the disclosure.

Various embodiments of the invention will be described in detail below, by way of example only, with reference to the accompanying drawings, wherein:

FIGS. 1A and 1B illustrate an attachment arrangement according to an advantageous embodiment of the invention,

FIG. 2 illustrates the lock ring according to an advantageous embodiment of the invention,

FIG. 3 illustrates a frame member of a lock base according to an advantageous embodiment of the invention,

FIG. 4 illustrates a holding mechanism according to an advantageous embodiment of the invention, and

FIGS. 5A and 58 illustrate a detail of an embodiment of the invention.

### DETAILED DESCRIPTION OF THE INVENTION

The following embodiments are exemplary. Although the specification may refer to “an”, “one”, or “some” embodiment(s), this does not necessarily mean that each such reference is to the same embodiment(s), or that the feature only applies to a single embodiment. Features of different embodiments may be combined to provide further embodiments.

In the following, features of the invention will be described with a simple example of a mechanism with which various embodiments of the invention may be implemented. Only elements relevant for illustrating the embodiments are described in detail. Details that are generally known to a person skilled in the art may not be specifically described herein.

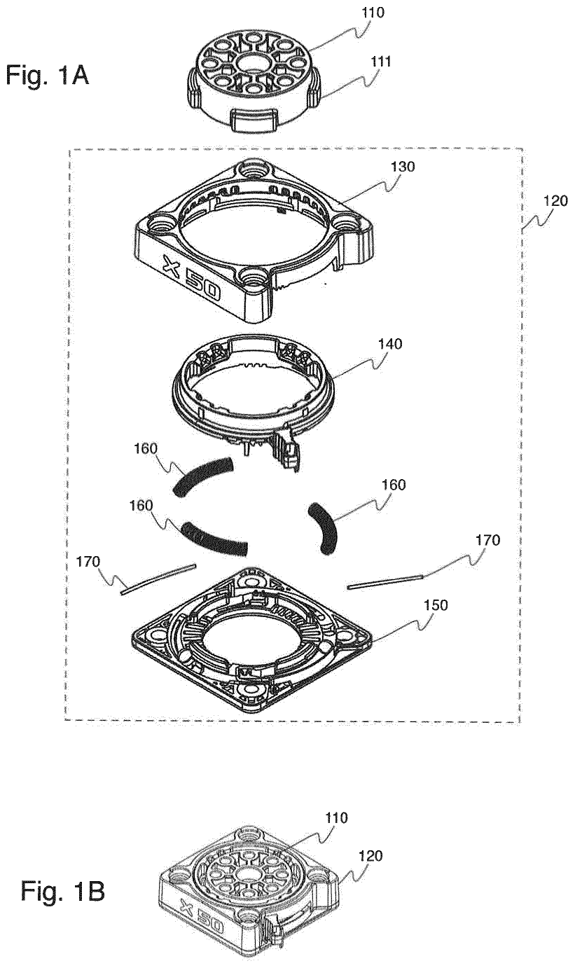

FIGS. 1A and 1B illustrate an attachment arrangement according to an advantageous embodiment of the invention. FIG. 1A shows an exploded view of an attachment arrangement. FIG. 1A shows a wedge plate 110, and components 130, 140, 150, 160, 170 of a lock base 120.

The lock base 120 comprises a frame member 130 and a bottom plate 150, and a lock ring 140 between the frame member 130 and the bottom plate 150. FIG. 1A also shows spring members 160 that are biased to push the lock ring 140 towards the locked position.

FIG. 1A also illustrates trigger mechanism spring members 170. The purpose of the trigger mechanism is to release the lock ring to rotate towards the closed position when a wedge plate 110 is inserted into the lock base 120.

FIG. 1B illustrates the lock base 120 in assembled form, with a wedge plate 110 inserted into it.

Advantageously, the wedge plate 110 and the bottom plate 150 comprise matching shapes that block the wedge plate from rotating when inserted into the lock base.

The wedge plate 110 comprises a plurality of wedges 111 as shown in FIG. 1A. Advantageously, the wedges 111 are located at the side of the wedge plate 110 as shown in FIG. 1A, with the bottom surfaces of the wedges 111 being substantially aligned with the bottom surface of the wedge plate 110. FIG. 1A illustrates an embodiment where the wedge plate 110 is injection molded plastic, and the wedge plate 110 has a larger height than the wedges 111. In a further embodiment of the invention, the wedge plate can be simply cut out of a metal plate or a plate of another material, in which case the bottom surface of the wedge plate and the wedges are the same continuous bottom surface, and the top surface of the wedge plate and the wedges are the same continuous top surface. Here the direction “down” and the corresponding concept of “bottom surface” refer to the direction of insertion of the wedge plate into the lock base, and do not limit the installation position of the inventive arrangement.

In a further embodiment of the invention the bottom surfaces of the wedges 111 may be at a distance from the plane of the bottom surface of the wedge plate 110, although such an embodiment has the drawback that introducing the the distance into the arrangement may require a corresponding increase in the total height of the arrangement, if other mechanical considerations such as load capacity remain the same.

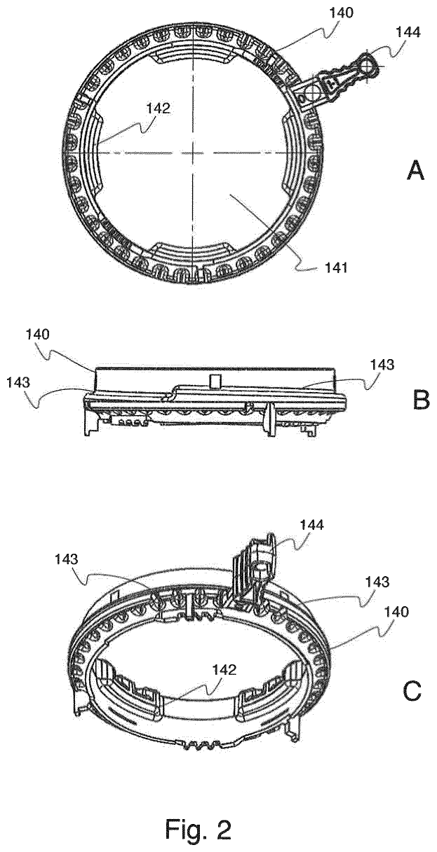

FIG. 2 illustrates in more detail the lock ring 140 according to an advantageous embodiment of the invention. View A shows the lock ring from above, view B from a side, and view C from obliquely below. View A illustrates that the lock ring 140 has an opening 141 shaped to accommodate a wedge plate. When the lock ring 140 is rotated within the lock base towards the locked position, wedges 142 of the lock ring cover the wedges of a wedge plate, thereby blocking egress of the wedge plate from the lock base. In the locked position, the wedges 142 mate with and at least partially cover the wedges of the wedge plate, securing the wedge plate into the lock base. View A also illustrates handle 144 of the lock ring 140. A user of the attachment mechanism can turn the lock ring using the handle 144.

View B illustrates that the lock ring has a plurality of inclined surfaces 143 for mating with corresponding inclined surfaces on the frame member, and for pressing the lock ring against the wedge plate when the lock ring is rotated towards the locked position.

For clarity, view C illustrates the lock ring from an oblique angle. View C also illustrates the inclined surfaces 143, the wedges 142, and the handle 144 of the lock ring 140.

The number of inclined surfaces 143 and their location on the lock ring 140 may be different in different embodiments of the invention. However, it is preferable that there is a plurality of the inclined surfaces 143 so as to provide pressure on the wedge plate evenly.

The number of wedges in a wedge plate may be different in different implementations of the invention. There may be for example two, three, four or more wedges in the wedge plate in different embodiments of the invention.

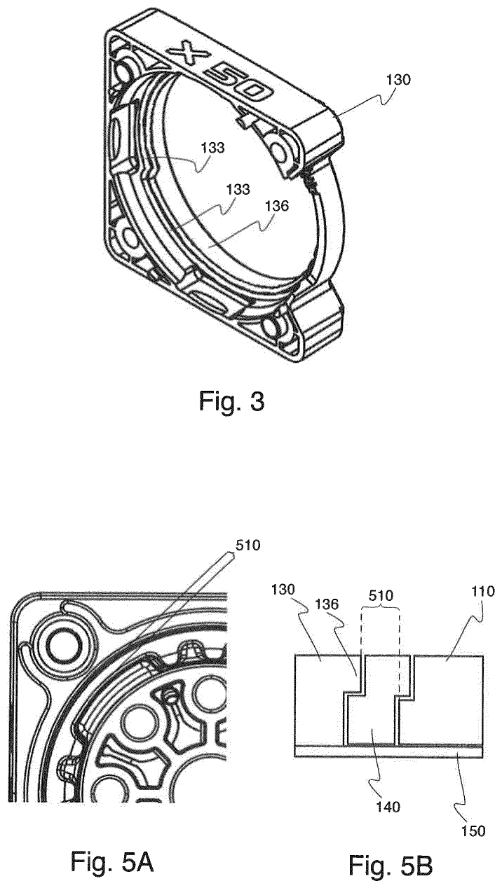

FIG. 3 illustrates a frame member of a lock base according to an embodiment of the invention. FIG. 3 shows the frame member 130 from an oblique angle, so that inclined surfaces 133 are visible. These inclined surfaces 133 mate with inclined surfaces 143 of the lock ring, pressing the lock ring down towards an inserted edge plate, when the lock ring is rotated towards the locked position.

A benefit of a structure like that illustrated in FIGS. 1 to 3 is that the tightening movement is created by interplay of the lock ring 140 and the frame member 130, which allows the wedge plate to be simple in construction, and to have flat surfaces mating with the lock ring. Such a simple construction is easier and cheaper to produce than solutions presented in prior art.

Embodiments illustrated in FIGS. 1 to 3 are merely one possible way to implement a movement of the lock ring towards the wedge plate, when the lock ring is rotated towards the locked position. In this embodiment, matching inclined surfaces 133, 143 are used to produce the movement. A person skilled in the art can devise many different ways of generating such movement from rotation of the lock ring, wherefore the invention is not limited to only the mechanisms illustrated in FIGS. 1 to 3.

The embodiments shown in FIGS. 1 to 3 also have the advantage, that they provide a self-tightening attachment arrangement. Any vibration of the arrangement or shocks experienced by the arrangement that causes any movement of a wedge plate inserted into the lock base and any movement of the lock ring, will cause the lock ring to rotate even more towards the closed position, pushed by spring members 160, thus further tightening the attachment.

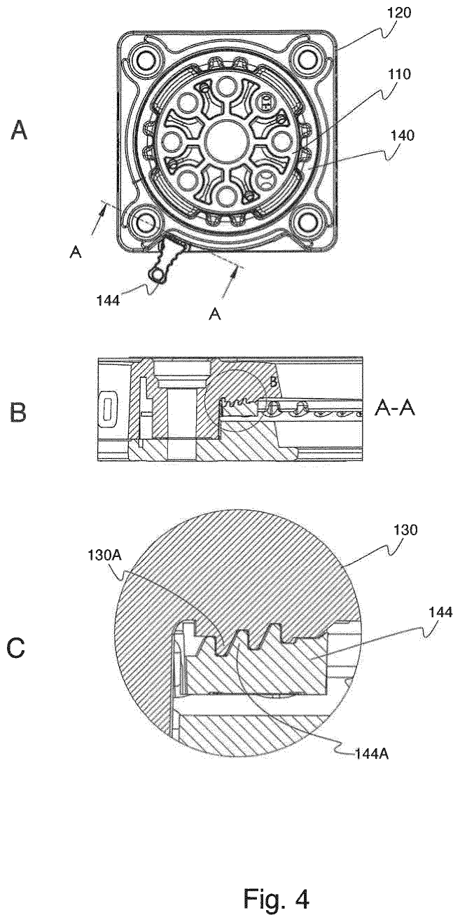

FIG. 4 illustrates a holding mechanism according to an embodiment of the invention. View A shows the lock base 120, with a wedge plate 110 inserted, and the lock ring in the open position. View A also shows the lock ring 140 and its handle 144. View A shows the line A-A, indicating the location of the cross-section A-A of view B. View C shows an enlargement of the cross section of view B, from the circled area in view B.

View C shows in detail the interaction between the frame member 130 and the handle 144 of the lock ring. The frame member 130 and the lock ring handle 144 have a set of matching notches 130A, 144A to hold the lock ring in place, when the lock ring has been rotated to the fully open position. This allows the placement of a wedge plate into the lock base without the lock ring 140 being released by the release trigger mechanism. This helps in the placement of large or heavy objects with attached wedge plates in the attachment arrangement. Only when the user presses the handle 144 disengaging the notches 130A, 144A the lock ring becomes free to rotate. This arrangement provides a convenient holding mechanism, which makes it easier to place the wedge plate in the lock base in certain situations.

FIG. 4 illustrates merely one example of an embodiment providing such a holding mechanism. A person skilled in the art can devise many other ways of providing notches and similar features to provide a holding mechanism, whereby this invention is not limited to a holding mechanism implemented as shown in the figure

One characteristic of a particular embodiment of the invention that allows for a sturdy structure having high load bearing capability is the arrangement, that the opening in the top side of the frame member 130 is circular, while the opening which is shaped like the wedge plate is implemented in the lock ring 140. In such an embodiment the lock ring is held in place within the lock base by a lip in the lock base, and the distance between the outermost edge of an inserted wedge plate and the innermost edge of the lip is larger than zero, measured along a direction perpendicular to the insertion direction of a wedge plate into the lock base. This distance 510 is illustrated in FIG. 5A, which shows a partial view of the attachment arrangement from above, i.e. from the direction from which the wedge plate is inserted into the attachment arrangement. The lip 136 in the frame member 130 is illustrated for example in FIG. 3, being the part 136 of the frame member where the inclined surfaces 133 are located.

Such an arrangement allows the lock ring to be thick, which allows transfer of large forces from the wedge plate through the lock ring into the frame of the lock base.

FIG. 58 further illustrates this structural principle. FIG. 58 shows a part of a schematic cross section of an attachment arrangement according to an embodiment of the invention. FIG. 58 illustrates the frame member 130, lock ring 140, wedge plate 110, and bottom plate 150, as well as the distance 510 between the innermost edge of the lip 136 of the frame member 130 and the outermost edge of a wedge of the wedge plate 110. When this distance 510 is larger than zero, i.e., the wedge plate does not go under any substantially load bearing part of the frame member 136, the lock ring 140 can be made almost as thick in the vertical direction of FIG. 5B as the frame member 130, and with substantial thickness in the lateral direction in FIG. 5B. In such a construction, the lock ring can transfer larger forces to frame member 130 that can happen in certain prior art solutions. This structural principle allows the attachment arrangement to be sturdy and resistant to high loads.

The invention has several benefits. For example, the invention is simpler in structure than prior art solutions, which makes the inventive structure cheaper to manufacture. Further, the inventive structure is more sturdy and has a higher load bearing capacity than prior art solution. The present invention also allows the wedge plate to have flat engaging surfaces, which makes that part simple and cheap to manufacture.

According to an aspect of the invention, a quick attachment arrangement is provided. The arrangement has a lock base and a rotatable lock ring within the lock base, the lock base and lock ring being arranged to receive a wedge plate for insertion into the lock base within the lock ring, and to securely attach an inserted wedge plate by rotation of the lock ring.

In a first embodiment according to this aspect of the invention, the lock ring is arranged to move, in a direction perpendicular to the plane of the lock ring, towards a wedge plate inserted into the lock base when rotated in a first direction for securing the wedge plate in the lock base, and to release the wedge plate when rotated in the second direction.

In a second embodiment according to this aspect of the invention, the lock ring comprises a plurality of first surfaces inclined at an angle in relation to the plane of the lock ring, and the lock base has matching inclined second surfaces to mate with the first surfaces and to press the lock ring towards a wedge plate inserted into the lock base when the lock ring is rotated in the first direction for securing the wedge plate in the lock base.

In a third embodiment according to this aspect of the invention, the arrangement further comprises a wedge plate.

In a fourth embodiment according to this aspect of the invention, the lock ring is held in place within the lock base by a lip in the lock base, and the distance between the outermost edge of an inserted wedge plate and the innermost edge of the lip is larger than zero, measured along a direction perpendicular to the insertion direction of a wedge plate into the lock base.

In a fifth embodiment according to aspects of the invention, in which embodiment the arrangement has a trigger mechanism for rotating the lock ring when a wedge plate is inserted into the lock base, the lock base comprises a holding mechanism to block the rotation of the lock ring when a wedge plate is inserted into the lock base and the trigger mechanism is triggered.

In view of the foregoing description, it will be evident to a person skilled in the art that various modifications may be made within the scope of the invention. While a preferred embodiment of the invention has been described in detail, it should be apparent that many modifications and variations thereto are possible, all of which fall within the true spirit and scope of the invention.

It is to be understood that the embodiments of the invention disclosed are not limited to the particular structures, process steps, or materials disclosed herein, but are extended to equivalents thereof as would be recognized by those skilled in the art. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another but are to be considered as separate and autonomous representations of the present invention.

Furthermore, the described features, structures, or characteristics may be combined in any suitable manner in one or more embodiments. In the previous description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A quick attachment mechanism, comprising:
a lock base;
a rotatable lock ring arranged within the lock base,
wherein the lock base and the lock ring are configured and arranged to receive a wedge plate for insertion into the lock base within the lock ring, and to securely attach an inserted wedge plate by rotation of the lock ring; and
wherein the lock ring is arranged to move in a direction perpendicular to a plane of, the lock ring, towards a wedge plate inserted into the lock base when rotated in a first direction for securing the wedge plate in the lock base, and to release the wedge plate when rotated in the second direction.

2. The mechanism according to claim 1, wherein the lock ring comprises a plurality of first surfaces inclined at an angle in relation to the plane of the lock ring, and the lock base further comprises matching inclined second surfaces arranged to mate with the first surfaces and configured to press the lock ring towards a wedge plate inserted into the lock base when the lock ring is rotated in the first direction for securing the wedge plate in the lock base.

3. The mechanism according to claim 1, further comprising a wedge plate.

4. The mechanism according to claim 1, wherein lock base further comprises a lip arrange and configured to hold the lock ring in place within the lock base, and wherein the distance between the outermost edge of an inserted wedge plate and the innermost edge of the lip is larger than zero, measured along a direction perpendicular to the insertion direction of a wedge plate into the lock base.

5. The mechanism according to claim 1, further comprising a trigger mechanism configured for rotating the lock ring when a wedge plate is inserted into the lock base, wherein the lock base further comprises a holding mechanism to block the rotation of the lock ring when a wedge plate is inserted into the lock base and the trigger mechanism is triggered.
